(19) United States
(12) Patent Application Publication
(10) Pub. No.: US 2024/0407564 A1
(43) Pub. Date: Dec. 12, 2024

(54) FLOOR PILLOW STRUCTURE

(71) Applicant: Plufl Bed LLC, MIDDLETOWN, DE (US)

(72) Inventors: Noah SILVERMAN, SEATTLE, WA (US); Yukinori KINOSKITA, BETHESDA, MD (US); Adelle DUBBLESTYNE, VANCOUER, BC (CA)

(73) Assignee: Plufl Bed LLC, MIDDLETOWN, DE (US)

(21) Appl. No.: 18/705,839

(22) PCT Filed: Jun. 22, 2023
(86) PCT No.: PCT/US2023/025963

§ 371 Date: Apr. 29, 2024

Related U.S. Application Data
(60) Provisional application No. 63/356,511, filed on Jun. 29, 2022.

(51) Int. Cl. A47C 27/08; A47C 27/12; A47C 31/08

(52) U.S. Cl. CPC A47C 27/086; A47C 27/088; A47C 27/124; A47C 31/08

(57) ABSTRACT

The present invention provides a floor pillow structure that is configured to maintain its shape and feel over extended use without relying on rigid frame components. In some embodiments this floor pillow structure integrates a floor pad and a bolster through a cover system that is configured to generate tension between the bolster and floor pad thereby imparting structure on an otherwise structureless component. Some embodiments of the present invention also provide a bolster-floor pad interface comprising a perimeter channel that is configured to allow a user of the invention to relieve joint and appendage pressure when using the floor pillow structure.

### CROSS REFERENCE TO RELATED APPLICATION

Pursuant to 35 U.S.C. § 119(e), this application claims priority from, and the benefit of, U.S. provisional application No. 63/356,511, filed on Jun. 29, 2022, the entire contents of which is hereby incorporated by reference for all purposes as if fully set forth.

### FIELD OF INVENTION

This application relates to the field of furniture, and more specifically to a floor pillow structure comprising an integrated perimeter bolster and base floor pad combination.

### BACKGROUND OF THE INVENTION

A myriad of casual furniture is designed for floor use and configured to allows the users to lounge, relax, and recline. This type of furniture may include dog beds, bean bag chairs, giant pillows, inflatable furniture, etc. Often this type of furniture will not include a more rigid internal framework to maintain the shape and feel of the furniture object because, over time, an internal rigid frame can become uncomfortable for the user, especially as the padding around the frame degrades with use. Still, over time, even with normal use, this type of frameless furniture will begin to suffer from sagging and degradation, and begin to lose its form and shapeliness. The result is often an unattractive furniture item that fails to offer the type of structure and support that it provided initially.

There is a need for a structured floor pillow that maintains its shape and feel over repeated use, without relying on a rigid internal framework. There is also a need for a structured floor pillow that includes a space between a base floor pad and bolster perimeter, which is configured to allow a user to utilize the space for relief on joints and appendages when reclining on and within the structured floor pillow.

### SUMMARY OF THE INVENTION

The present invention provides a floor pillow structure that is configured to maintain its shape and feel over extended use without relying on rigid frame components. In some embodiments this floor pillow structure integrates a floor pad and a bolster through a cover system that is configured to generate tension between the bolster and floor pad thereby imparting structure on an otherwise structureless component. Some embodiments of the present invention also provide a bolster-floor pad interface comprising a perimeter channel that is configured to allow a user of the invention to relieve joint and appendage pressure when using the floor pillow structure.

### BRIEF DESCRIPTION OF THE DRAWINGS

The accompanying drawings are fully incorporated in, and form part of, this specification, and illustrate embodiments of the invention that, together with the description, explain principles of the invention:

FIG. 1 depicts an assembled floor pillow structure according to an embodiment of the invention;

FIG. 2A depicts a base floor pad according to an embodiment of the invention;

FIG. 2B depicts bolster components according to an embodiment of the invention;

FIG. 2C depicts a floor pillow structure cover according to an embodiment of the invention;

FIG. 3A depicts the insertion of bolster components into a floor pillow structure according to an embodiment of the invention;

FIG. 3B depicts bolster components inserted into a floor pillow structure cover according to an embodiment of the invention;

FIG. 3C depicts a floor pillow structure cover with bolster components installed according to an embodiment of the invention;

FIG. 3D depicts the insertion of a base floor pad into a floor pillow structure cover according to an embodiment of the invention;

FIG. 4 depicts a cutaway view of a floor pillow structure with the installed bolster and base floor pad according to an embodiment of the invention;

FIGS. 5A, 5B, 5C, and 5D depict side views of a floor pillow structure according to an embodiment of the invention;

FIG. 6 depicts a top-down view of a floor pillow structure according to an embodiment of the invention;

FIG. 7 depicts a handle component according to an embodiment of the invention; and

FIG. 8 depicts a side pillow pocket component according to an embodiment of the invention.

### DETAILED DESCRIPTION OF THE INVENTION

Reference will now be made in detail to embodiments of the invention, examples of which are illustrated in the accompanying drawings. While the invention is described in conjunction with these embodiments, it will be understood that the descriptions herein are not intended to limit the invention to these embodiments. On the contrary, the invention is intended to cover alternatives, modifications, and equivalents that may be included within the spirit and scope of the invention as defined by the appended claims. Detailed description of components that are well known in the art may be omitted if that detailed description would confuse or obscure the description of the embodiments of the present invention.

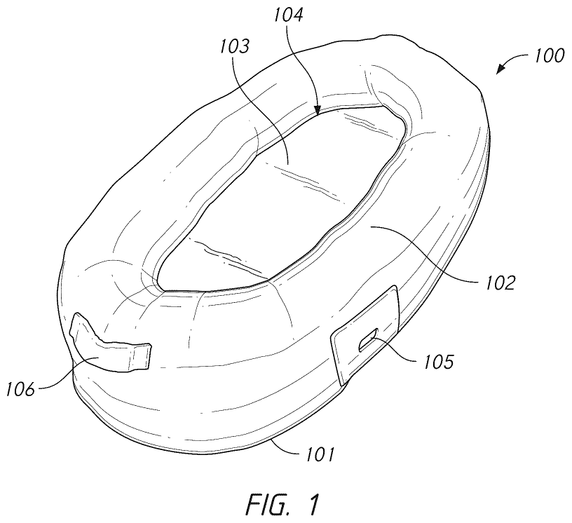

FIG. 1 depicts an assembled floor pillow structure 100 according to an embodiment of the invention. As depicted in FIG. 1, and as will be described in more detail below, floor pillow structure 100 is defined by floor pillow structure cover 101. Floor pillow structure cover 101 houses bolster components that define bolster perimeter 102. Bolster perimeter 102 is flush with base floor pad 103, and defines channel 104, which will be described in more detail below. FIG. 1 also depicts side pocket 105 and side handle 106, according to an embodiment of the invention. As depicted in FIG. 1, floor pillow structure cover 101 captures the internal bolster components and restrains the material with respect to the internal floor pad components. As a result bolster perimeter 102 fully sits on top of the floor base pad, providing a tidy appearance, while also providing support for the body of the user of floor pillow structure 100.

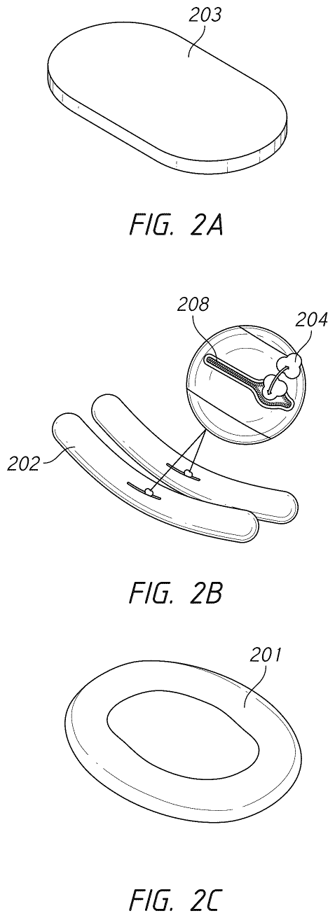

FIGS. 2A, 2B, and 2C depict the unassembled components of a floor pillow structure according to an embodiment of the invention. FIG. 2A depicts an example base floor pad 203 that is configured to be inserted into a floor pillow structure cover according to an embodiment of the invention. Base floor pad 203 may comprise a layer or layers of materials, including high-quality polyurethane foam, memory foam, latex foam, batting, etc. In some embodiments, base floor pad 203 may be configured to be inflatable.

FIG. 2B depicts bolster components 202 that are configured to be inserted into a floor pillow structure according to an embodiment of the invention. In some embodiments, bolster components 202 may comprise a bolster cover configured to be filled with batting, poly-fil, down feathers, memory foam pieces, Styrofoam beads, etc. In some embodiments, bolster components 202 include openings 208 so that the user can adjust the level of stuffing 204, thereby adjusting the firmness of the bolster perimeter in the floor pillow structure. In some embodiments, bolster components 202 may be configured to be inflatable. Although FIG. 2B depicts two bolster components 202 for creating the bolster perimeter in the floor pillow structure, other configurations are contemplated by this invention, including a single bolster component, or more than two bolster components.

FIG. 2C depicts floor pillow structure cover 201 without bolster components or base floor pad installed. Floor pillow structure cover 201 is configured to keep the bolster components firmly attached to the top of the base floor pad so that the bolster perimeter does not fall over the edge of the base floor pad. In some embodiments, floor pillow structure cover 201 is also configured to provide an internal channel between the bolster perimeter and the base floor pad, which will be described in more detail below. In some embodiments, floor pillow structure cover 201 may be constructed from faux fur material, canvas, neoprene, denim, etc. In some embodiments floor pillow structure cover 201 may be constructed out of a waterproof material, and/or a material treated to provide mildew resistance. In some embodiments the bottom of floor pillow structure cover 201 may be provided with a non-skid, tacky, or grippy material, such as silicone or rubber, to prevent the floor pillow structure from sliding around during use.

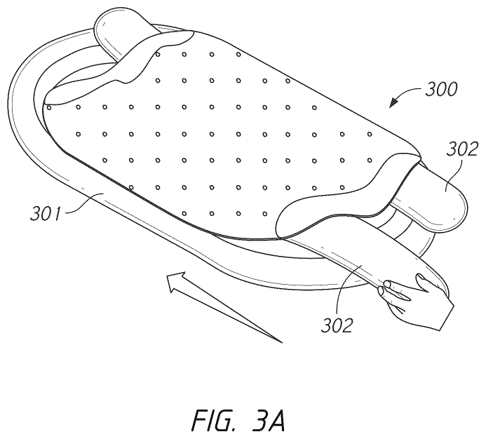

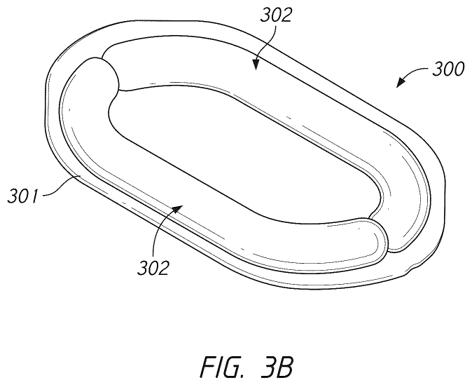

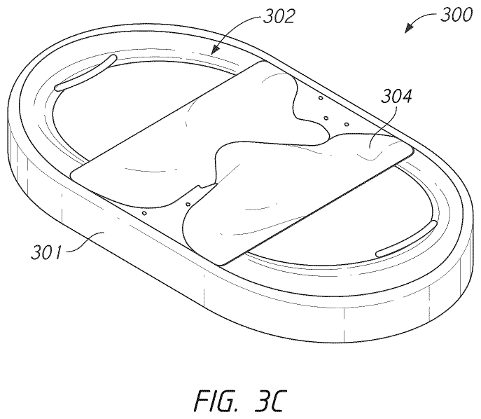

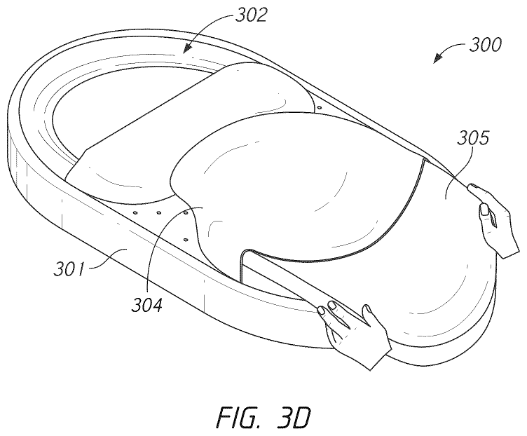

FIGS. 3A, 3B, 3C, and 3D depict various stages of assembly of a floor pillow structure 300 according to an embodiment of the invention. FIG. 3A depicts the insertion of bolster components 302 into floor pillow structure 301. Bolster components 302 are inserted into, and enclosed within, a bolster perimeter chamber, which will be discussed further below. FIG. 3B depicts bolster components 302 inserted into floor pillow structure cover 301 before insertion of a base floor pad into floor pillow structure cover 301 according to an embodiment of the invention. As depicted in FIG. 3B, bolster components 302 are enclosed within a bolster perimeter chamber 303 that is integrated into floor pillow structure cover 301, according to an embodiment of the invention. FIG. 3C also depicts bottom panel 304, which is open on either end to accept insertion of a base floor pad. While FIG. 3C depicts a single bolster perimeter chamber, multiple sections of bolster perimeter chambers are contemplated according to other embodiments of the invention.

FIG. 3D depicts the insertion of base floor pad 305 into the floor pillow structure cover 301 according to an embodiment of the invention. As depicted in FIG. 3D, floor pillow structure cover 301 contains a separate chamber from the chamber that contains bolster components 302, which is configured to accept base floor pad 305. After base floor pad 305 is fully installed into floor pillow structure cover 301, each end of floor pillow structure cover can be closed so that floor pillow structure 300 is ready for use. While FIGS. 3A, 3B, 3C, and 3D depict zippers for closing the bolster perimeter and base floor pad chambers, a person of ordinary skill in the art would understand that other fastening systems could be integrated, including, but not limited to, snaps, hook and loop fasteners, lacing, etc. As will be described in more detail herein, in some embodiments, the dimensions of the base floor pad are sized in such a way that the base floor pad must be compressed to be fully installed into the base floor pad chamber. After the base floor pad is installed into the base floor pad chamber, the base floor pad expands and exert pressure against the walls of the base floor pad chamber. The pressure creates a tension between the base floor pad and the bolster perimeter that helps to align the bolster perimeter with the sides of the base floor pad, preventing the bolster and bolster perimeter from sagging over the edge of the base. The tension on the outer edge that forces the bolster perimeter to stay on top of the base floor pad also creates a channel-like space between the bolster perimeter and the base floor pad, which will be described in further detail below.

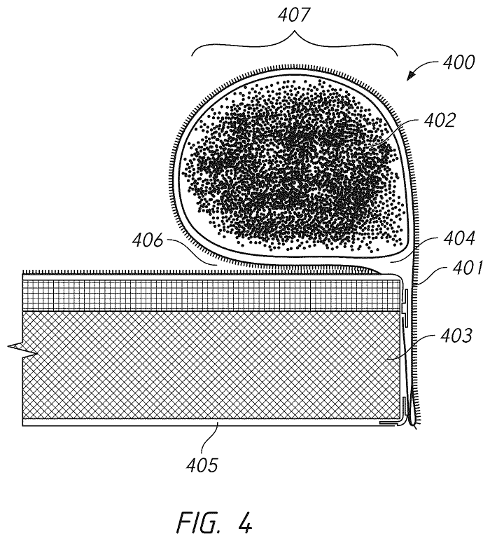

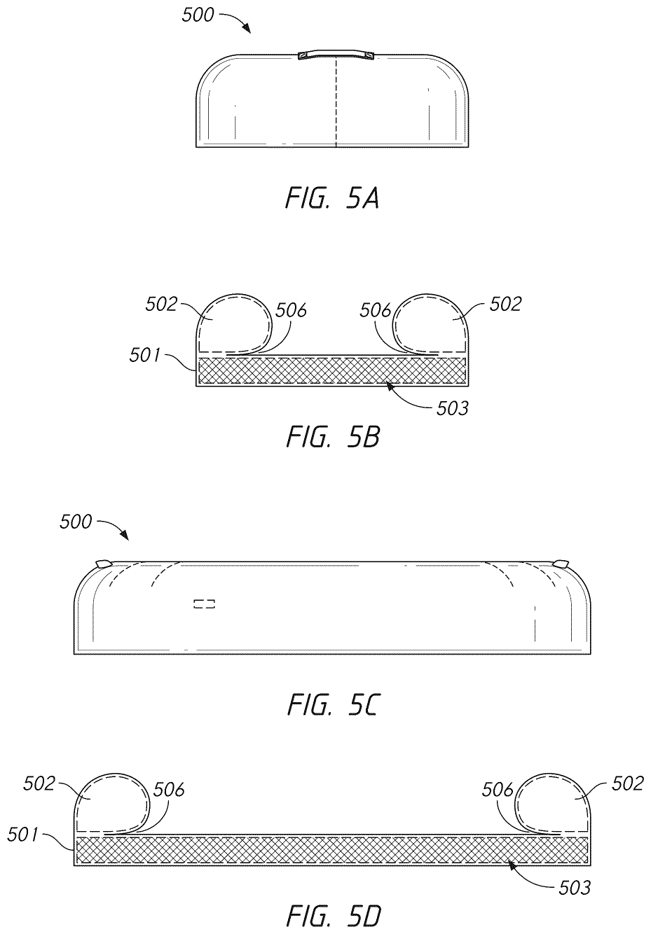

FIG. 4 depicts a cutaway view of floor pillow structure 400 with bolster component 402 and base floor pad 403 installed into floor pillow structure cover 401 according to an embodiment of the invention. As depicted in FIG. 4, bolster component 402 is encased within bolster chamber 404, while base floor pad 403 is encased within base floor pad chamber 405. FIG. 4 also depicts channel 406, which is created between bolster perimeter 407 and base floor pad 403. Channel 406 is configured to allow a user to place an appendage between the bolster perimeter and the base floor pad, thereby allowing a user to alleviate pressure on a joint or appendage. For example, a user may place an arm or leg within channel 406 while using bolster perimeter 407 to support the user's head or feet. The channel is further discussed below with respect to FIG. 5.

FIGS. 5A, 5B, 5C, and 5D depict side views of a floor pillow structure 500 according to an embodiment of the invention. FIGS. 5A and 5C depict two different exterior side views of floor pillow structure 500. FIGS. 5B and 5D depict two different cutaway side views of floor pillow structure 500. As depicted in FIGS. 5B and 5D, bolster perimeter 502 lays on top of floor pad 503 and is positioned and retained by floor pillow structure case 501. This positioning of bolster perimeter 502 creates a channel 506 that runs around the perimeter of the interior of floor pillow structure 500, between the top of floor pad 503 and the bottom of bolster perimeter 502. As discussed above, a user of can place their hands, arms, feet, or legs in channel 506 to increase their comfort level when using floor pillow structure 500.

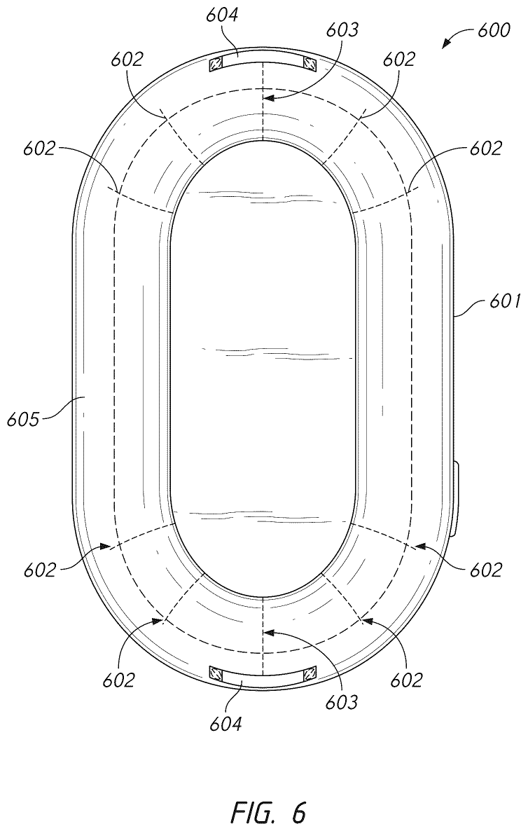

FIG. 6 depicts a top-down view of a floor pillow structure 600 according to an embodiment of the invention. As depicted in FIG. 6, floor pillow case 601 includes a number of darts 602 and long seams 603 that contribute to the structure of bolster perimeter 605. Darts 602 and long seams 603 bunch and structure the material comprising floor pillow case 601, to help further retain and direct the bolster components around the top perimeter of the floor pad. In some embodiments, the darts 602 and long seams 603 work in combination with the floor pad pressure and tensioning described with respect to FIG. 4 above to ensure that the bolster perimeter does not sag over the edge of the floor pad component of floor pillow structure 600. FIG. 6 also depicts handle components 604, which are described in further detail below.

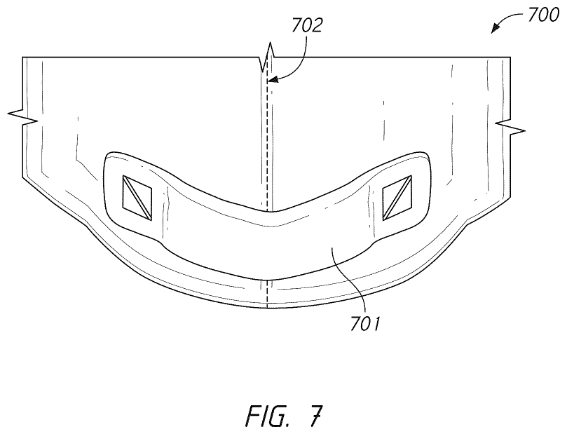

FIG. 7 depicts handle component 701 that is integrated into a floor pillow structure 700, according to an embodiment of the invention. Handle component 701 may configured assist a user in moving floor pillow structure 700 around. In some embodiments, floor pillow structure 700 may include two handle components at opposite ends. Handle components 701 may be configured in such a way that when the floor pillow structure is folded in half, a user can fasten the handles together, thereby making the floor pillow structure more compact and more easily transportable. In some embodiments, handle components 701 may be fastened together by a separate fastener, for example a hook and loop structure, or a structure with a buckle for fastening. In some embodiments, handle components 701 may be positioned over long seam 702 on either end of floor pillow structure 700.

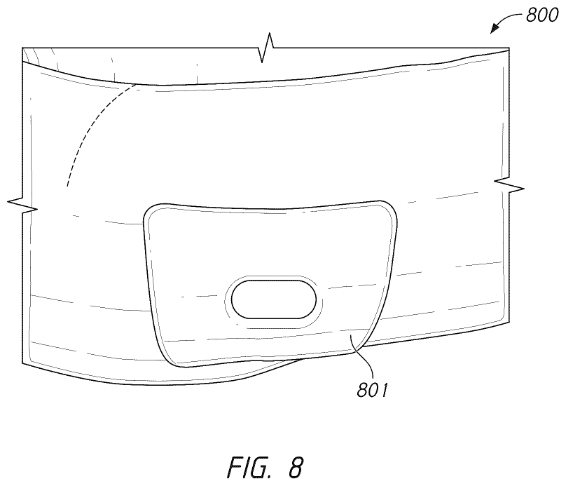

FIG. 8 depicts side pillow pocket 801 component attached to floor pillow structure 800 according to an embodiment of the invention. Side pillow pocket 801 may be configured to retain accessories to floor pillow structure 800, for example, such as fastening implements described with respect to FIG. 7 above. In some embodiments floor pillow structure 800 may be arranged with multiple side pillow pockets. In some embodiments one or more side pillow pockets may be arranged on the interior side of the bolster perimeter of floor pillow structure 800.

Although several example embodiments of the invention have been described herein, it should be understood that numerous other modifications and embodiments of the invention can be devised by those skilled in the art that will fall within the scope of the principles of this disclosure. More particularly, variations and modifications are possible in the component parts and/or arrangements of the inventive subject matter within the scope of the disclosure, the drawings, and the appended claims. In addition to variations and modifications in the component parts and/or arrangements, alternative uses and applications of the invention will also be apparent to those skilled in the art.

What is claimed is:

1. A furniture system comprising:
a base comprising a base chamber in a cover configured to accept a floor pad;
a bolster comprising a bolster chamber in the cover configured to accept one or more bolsters;
wherein the base chamber and bolster chamber are attached at a perimeter, and
wherein the floor pad is configured to exert pressure on the base chamber and the bolster chamber when installed in the base chamber.

2. The furniture system according to claim 1, wherein the floor pad comprises one or more layers of foam material.

3. The furniture system according to claim 1, wherein the bolster chamber is attached along the entire perimeter of the base chamber.

4. The furniture system according to claim 1, wherein the pressure exerted by the floor pad prevents the bolster chamber from sagging over the edge of the floor pad in the base chamber.

5. The furniture system according to claim 1, wherein the filling level of the one or more bolsters is adjustable.

6. The furniture system according to claim 1, further comprising a channel between the base and bolster.

7. The furniture system according to claim 6, wherein the channel runs along an inner perimeter of the base and is configured to be accessible to a user positioned in the interior of the bolster on the base.

8. The furniture system according to claim 1, wherein cover is provided with a non-skid surface on the bottom, underneath the floor pad.

9. The furniture system according to claim 1, wherein the bolster chamber is configured to be enclosed separately from the base chamber.

10. The furniture system according to claim 9, wherein the bolster chamber is configured to be closed by one of buttons, snaps, zippers, or hook-and-loop fasteners.

11. The furniture system according to claim 1, wherein the base chamber is configured to be enclosed separately from the bolster chamber.

12. The furniture system according to claim 11, wherein the base chamber is configured to be closed by one of buttons, snaps, zippers, or hook-and-loop fasteners.

13. The furniture system according to claim 1, wherein the bolster chamber is attached on top of the base chamber.

14. The furniture system according to claim 1, further comprising one or more handles attached to a side of the cover.

15. The furniture system according to claim 14, wherein the one or more handles are configured to be attached to one another.

16. The furniture system according to claim 1, further comprising one or more pockets attached to a side of the cover.

17. The furniture system according to claim 1, wherein the furniture system is configured to be folded.

18. The furniture system according to claim 1, wherein the one or more bolsters are filled with one or more of batting, poly-fil, down feathers, memory foam pieces, or Styrofoam beads.

19. A floor pillow structure comprising:
a base floor pad; and
a perimeter bolster that is attached around an outer perimeter of the base floor pad,
wherein the base floor pad is configured to provide tension on the perimeter bolster such that the perimeter bolster does not sag over the edge of the base floor pad.

20. A method of retaining a bolster on a floor pillow structure comprising:
attaching the bolster to a base floor pad at an outer perimeter of a base floor pad so that the bolster rests on top of the base floor pad,
wherein the base floor pad is configured to provide tension on the bolster such that the bolster is prevented from sagging over a top edge of the base floor pad.
